(19) United States
(12) Patent Application Publication
(10) Pub. No.: US 2015/0092418 A1
(43) Pub. Date: Apr. 2, 2015

(54) LIGHT CONTROL SYSTEM FOR A LUMINAIRE UTILIZING A LAMP WITH AND INTENSE HOTSPOT

(71) Applicants: Pavel JURIK, Postredni Becva (CZ); Josef Valchar, Postredni Becva (CZ)

(72) Inventors: Pavel JURIK, Postredni Becva (CZ); Josef Valchar, Postredni Becva (CZ)

(21) Appl. No.: 14/042,759

(22) Filed: Oct. 1, 2013

(51) Int. Cl. F21S 10/00

(52) U.S. Cl. CPC F21S 10/007
USPC 362/282

(57) ABSTRACT

Automatic light control system for a Luminaire with a light source and beam forming light collector with and intense hotspot. The Luminaire automatically selects a large aperture when a gobo is selected. When no gobo is selected then a medium aperture is automatically selected. In some embodiments these selections can be overridden. In some embodiments the large and medium aperture are on a non-glass gobo wheel. In further embodiments, when blackout is selected, this wheel automatically advances ½ position or 1 and ½ position so as to support a blackout state of the fixture until a non-blackout condition is selected.

### TECHNICAL FIELD OF THE INVENTION

The present invention generally relates to an automated luminaire, specifically to a light control system in an automated luminaire.

### BACKGROUND OF THE INVENTION

Luminaires with automated and remotely controllable functionality are well known in the entertainment and architectural lighting markets. Such products are commonly used in theatres, television studios, concerts, theme parks, night clubs and other venues. A typical product will commonly provide control over the pan and tilt functions of the luminaire allowing the operator to control the direction the luminaire is pointing and thus the position of the light beam on the stage or in the studio. Typically this position control is done via control of the luminaire's position in two orthogonal rotational axes usually referred to as pan and tilt. Many products provide control over other parameters such as the intensity, color, focus, beam size, beam shape and beam pattern. The beam pattern is often provided by a stencil or slide called a gobo which may be a steel, aluminum or etched glass pattern. The products manufactured by Robe Show Lighting such as the Robin MMX Spot are typical of the art.

The optical systems of such automated luminaires may be designed such that a very narrow output beam is produced so that the units may be used with long throws or for almost parallel light laser like effects. These optics are often called ‘Beam’ optics. To form this narrow beam with the large light sources in the prior art the output lens either needed to be very large with a large separation between the lens and the gobos or of a short focal length and much closer to the gobos. It is problematic to use a large separation with a large lens as such an arrangement makes the luminaire large and unwieldy and makes automation of the pan and tilt movement difficult. Thus the normal solution is a closer and smaller lens with a short focal length. Alternatively the thick heavy front lens may be replaced with a Fresnel lens where the same focal length is achieved with a much lighter molded glass lens using multiple circumferential facets. Fresnel lenses are well known in the art and can provide a good match to the focal length of an equivalent plano-convex lens, however the image projected by such a lens is typically soft edged and fuzzy and not a sharp image as may be desired when projecting gobos or patterns.

FIG. 1 illustrates a multiparameter automated luminaire system 10. These systems commonly include a plurality of multiparameter automated luminaires 12 which typically each contain on-board a light source (not shown), light modulation devices, electric motors coupled to mechanical drives systems and control electronics (not shown). In addition to being connected to mains power either directly or through a power distribution system (not shown), each luminaire is connected is series or in parallel to data link 14 to one or more control desks 15. The luminaire system 10 is typically controlled by an operator through the control desk 15. Control of the automated luminaire 12 is effectuated by electromechanical devices within the luminaire 12 and electronic circuitry 13 including firmware and software within the control desk 15 and/or the luminaire 12. In many of the figures herein, important parts like electromechanical components such as motors and electronic circuitry including software and firmware and some hardware are not shown in order to simplify the drawings so as to teach how to practice the inventions taught herein. Persons of skill in the art will recognize the need for these parts and should be able to readily fill in these parts.

FIG. 2 illustrates a prior art automated luminaire 12. A lamp 21 contains a light source 22 which emits light. The light is reflected and controlled by reflector 20 through a hot mirror 23, aperture or imaging gate 24, and optical devices 25, 27 which may include dichroic color filters, effects glass and other optical devices well known in the art. Optical components 27 are the imaging components and may include gobos, rotating gobos, iris and framing shutters. The final output beam may be transmitted through focusing lens 28 and output lens 29. Lens 29 may be a short focal length glass lens or equivalent Fresnel lens as described herein. Either optical components 27, lens 28, or lens 31 may be moved backwards and forwards along the optical axis to provide focus and/or beam angle adjustment for the imaging components. Hot mirror 23 is required to protect the optical systems 25 and 27 from high infra-red energy in the light beam and typically comprises a glass plate with a thin film dichroic coating designed to reflect long wavelength infra-red light radiation and only allow the shorter wavelength, visible, light to pass through and into the optical system.

More recently lamps 21 with extremely small light sources 22 have been developed. These often use a very short arc gap, of the order of 1 mm, between two electrodes as the light producing means. These lamps are ideal for producing a very narrow beam as their source etendue is low, and the size of the lenses and optical systems to collimate the light from such a small source can be substantially reduced. However, the short arc and small light source coupled with the short focal length, and thus large light beam angles, of the reflector also tend to produce substantial amounts of unwanted and objectionable spill light which can escape between gobos or around the dimming shutters.

There is a, increased need for an improved light control system for an automated luminaire utilizing a light source with an intense hotspot such that light spill around or between gobos and/or through the dimming shutter is reduced.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a typical automated lighting system;

FIG. 2 illustrates a prior art automated luminaire;

FIG. 3 illustrates an embodiment of an improved light engine for automated luminaires with high hot spot, non even beam profiles and gobos;

FIG. 4 illustrates an isometric view of an embodiment illustrated in FIG. 3;

FIG. 5 illustrates an isometric view of the embodiment illustrated in FIG. 3;

FIG. 6 illustrates a view of the static gobo wheel of an embodiment illustrated in FIG. 3;

FIG. 7 illustrates a view of the rotating gobo wheel of an embodiment illustrated in FIG. 3;

FIG. 8 illustrates an embodiment of a logic flow chart of the control of the light control system where the aperture size is automatically selected based on selections of the rotating and static gobos; and

FIG. 9 illustrates an embodiment of a logic flow chart of the control of the light control system during a mechanical blockout.

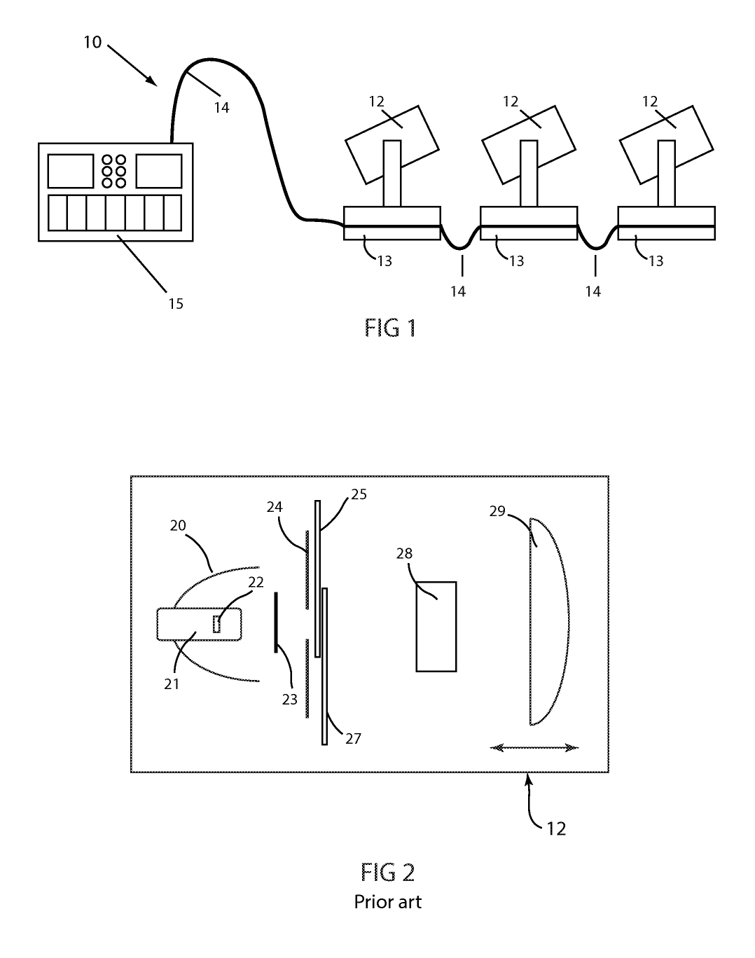

### DETAILED DESCRIPTION OF THE INVENTION

Preferred embodiments of the present invention are illustrated in the FIGUREs, like numerals being used to refer to like and corresponding parts of the various drawings.

The present invention generally relates to an automated luminaire, specifically to the design and operation of a light control system for use within the automated luminaire utilizing a light source with an intense hotspot such light spill around or between gobos and/or through the dimming shutter is reduced.

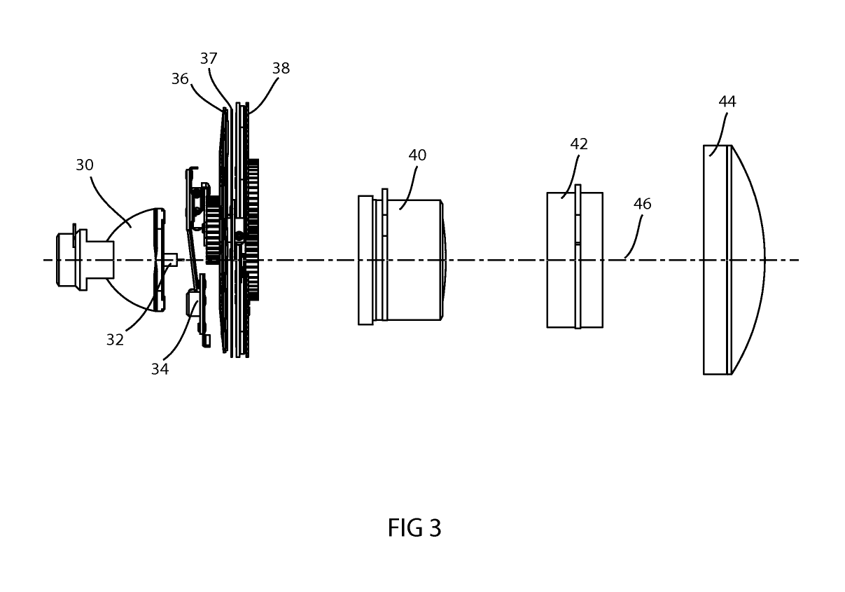

FIG. 3 illustrates an embodiment of the invention. The automated luminaire contains a light source 32 within reflector 30. Light source 32 may be a short arc discharge lamp with arc length of approximately 1 mm, and reflector 30 may be an ellipsoidal glass reflector. The combination of a short arc light source and an ellipsoidal reflector is well known in the art and produces a light beam towards the second focus of the ellipsoidal reflector. Such a beam typically has a very high energy beam center, or hotspot, which can be damaging to downstream optics and also produces a poor wide beam pattern when trying to use the luminaire as a wash light. The light beam passes through the heat protection and homogenization system 34 before passing through optical systems such as, for example, color system 36, static gobo system 37, and rotating gobo system 38. The light beam then continues through lenses 40, 42, and 44 which may each individually or cooperatively be capable of movement along optical axis 46 so as to alter the focus and beam angle or zoom of the light beam.

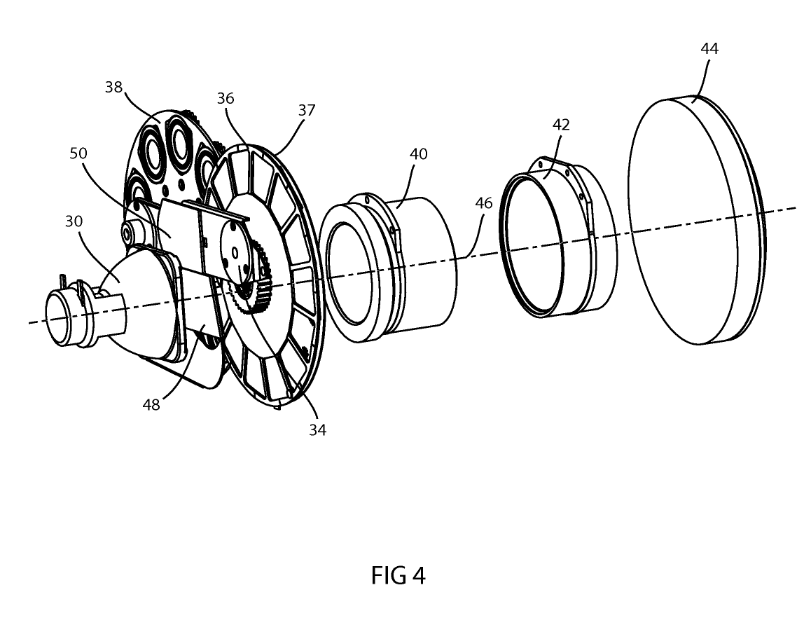

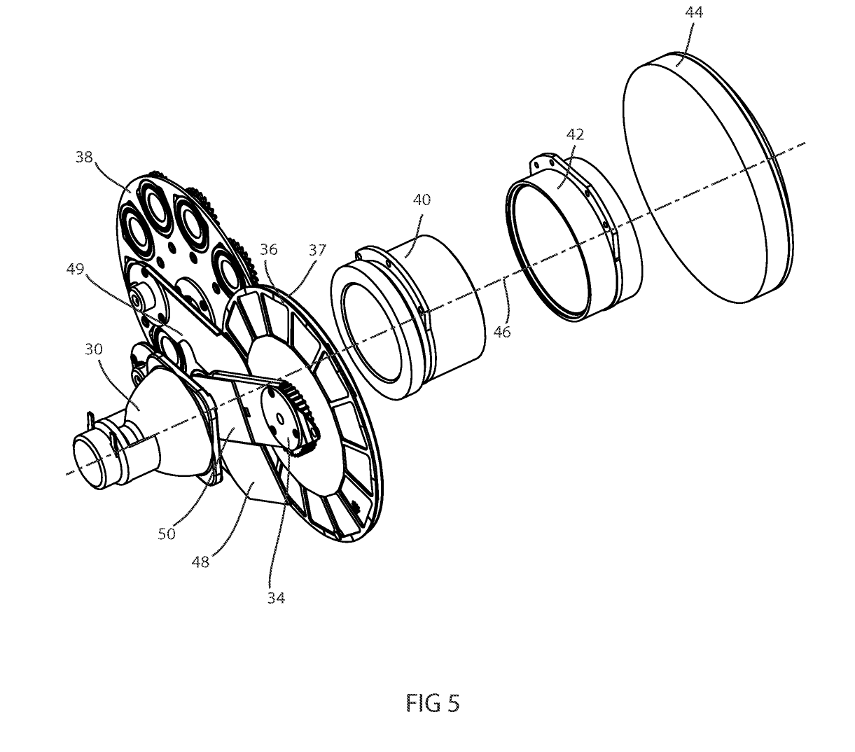

Because of the short focal length of the lamp 32 and reflector 30 the light beam passing through the static gobo wheel 37, and rotating gobo wheel 38 is sharply diverging, far from a parallel beam. This diverging beam provides increased possibility for light spill through one gobo on the first wheel past the edges of another gobo on the second wheel. FIG. 4 illustrates a perspective view of an embodiment of the invention which more clearly shows the gobo wheels providing the light control system. The light control system utilizes coordinated control of the static gobo wheel 37 and rotating gobo wheel 38 in order to minimize light spill.

FIG. 5 illustrates a further perspective view of an embodiment of the invention which more clearly shows the dimmer shutter 49 as well as the static gobo wheel 37 and rotating gobo wheel 38.

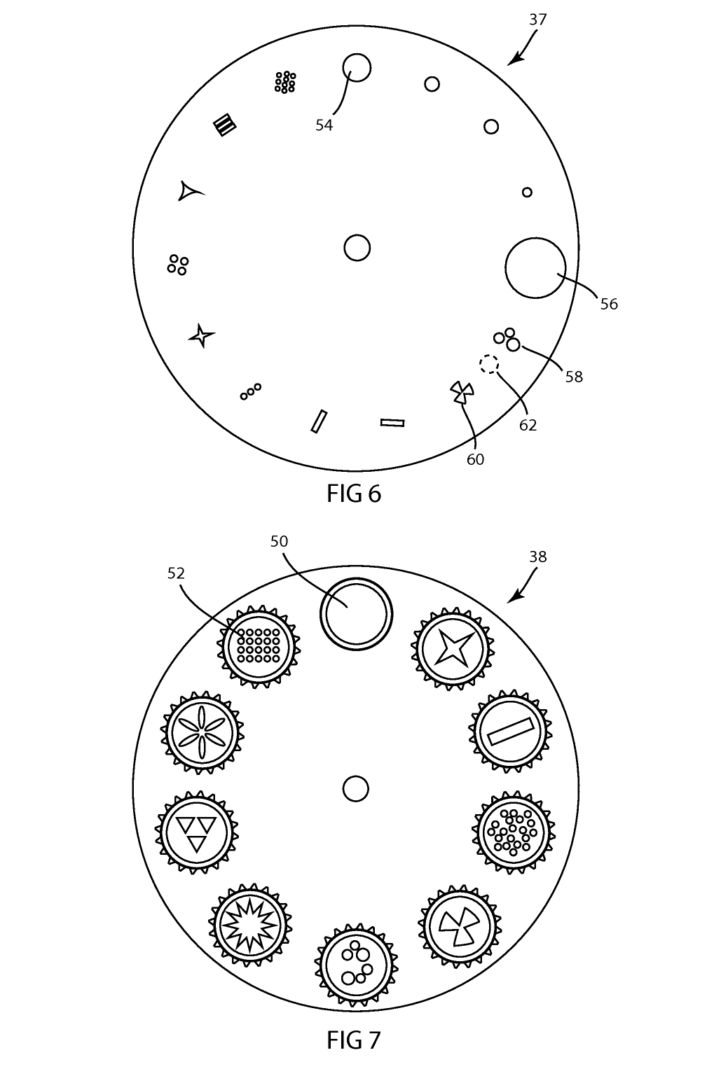

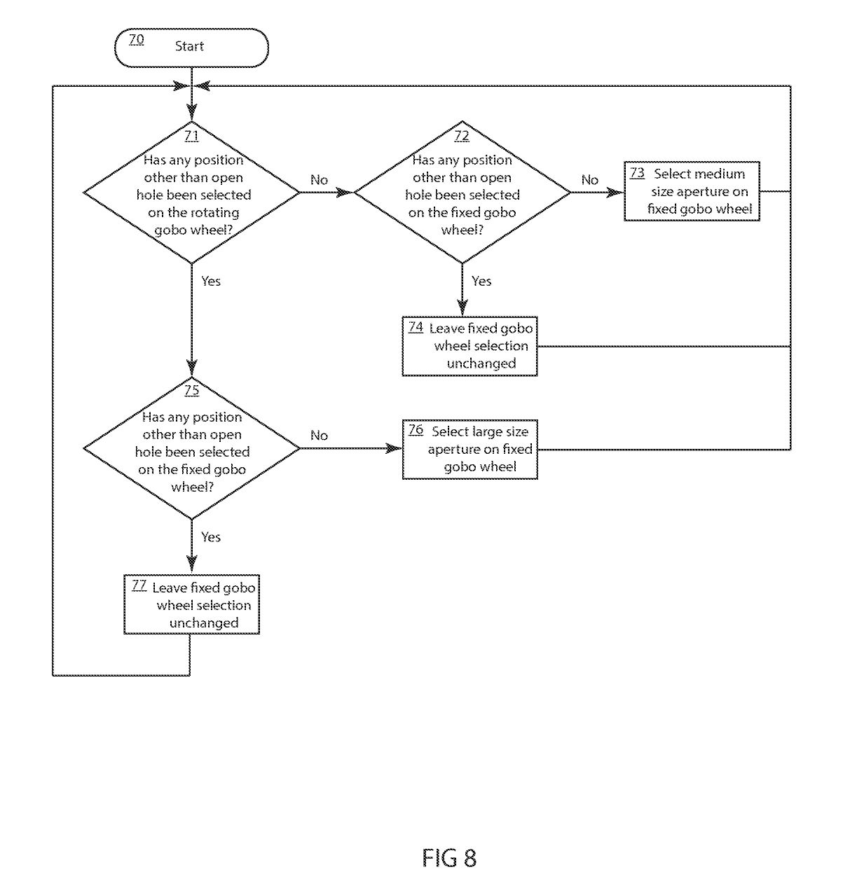

FIGS. 6 and 7 illustrate detailed views of the static gobo wheel 37 and rotating gobo wheel 38. Static gobo wheel 37 contains a plurality of patterns or gobos such as 58 and 60. It further contains a range of sizes of circular apertures including large aperture 56 and medium aperture 54. Similarly rotating gobo wheel 38 contains a plurality of patterns or gobos such as 52 each of which may be rotated about its central axis. It also contains a full aperture 50 with no pattern or gobo, usually called the open hole.

In operation the light control system coordinates the use of the full 56 and medium sized 54 apertures on the fixed gobo wheel 37 with the movement of the rotating gobo wheel 38 in order to minimize light spill. If the user is only utilizing the fixed gobo wheel 37 and the rotating gobo wheel 38 is positioned such that the open hole 50 is across the light path, then the system will utilize the medium aperture 54 as being the open hole for that wheel. In such case the large aperture 56 cannot be selected by the user and the system will avoid it when the wheel is rotated. The use of the medium aperture 54 instead of the large aperture 56 avoids excessive light spill from the large aperture 56 which could create haloes and patterns in the light beam. However, as soon as the user selects any gobo on rotating gobo wheel 38 other than the open hole 50, such as gobo 52, then the static gobo wheel 37 will automatically rotate from the medium aperture 54 to the large aperture 56 as its open hole. The use of the large aperture 56 on static gobo wheel in conjunction with any gobo other than the open aperture on the rotating gobo wheel results in improved light output through the rotating gobo wheel and, because a rotating gobo is in place, the risk of light spill is minimized.

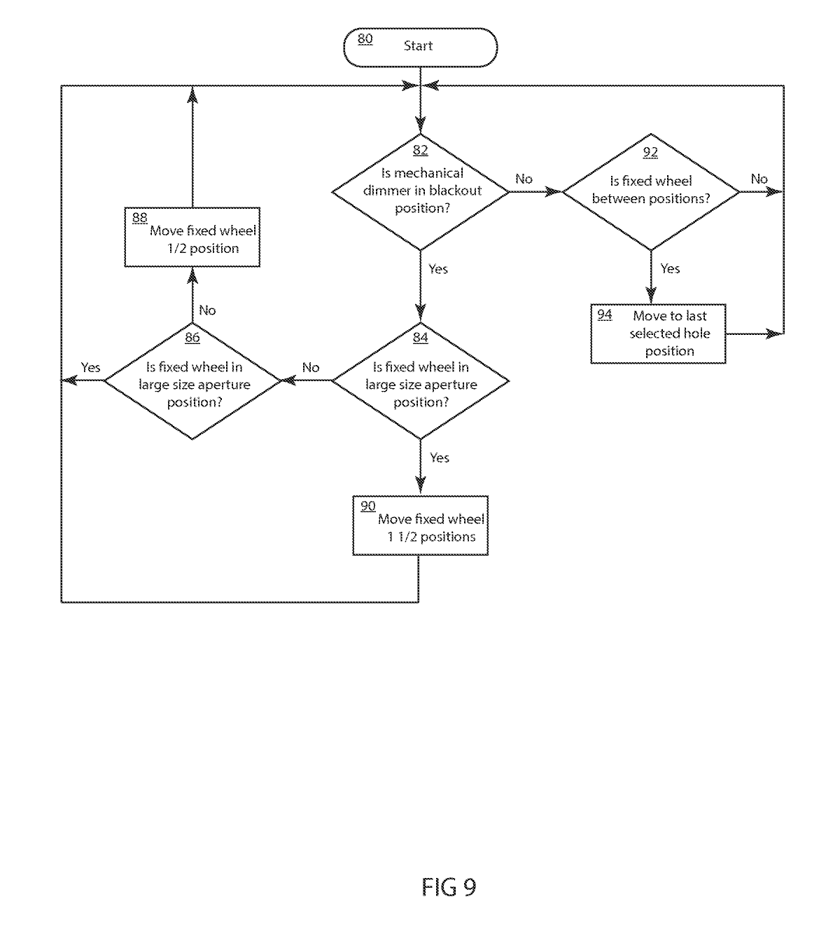

FIG. 8 shows the flow chart which clarifies the algorithm by which the software in the automated light will determine the relative automatic movements of the static gobo wheel 37 and rotating gobo wheel 38 to use the appropriate sized aperture as the open hole on the fixed gobo wheel 37. Such a system provides an advantage to the user in that it maximizes the light output from the system when using rotating gobos while minimizing light spill at all times, with any combination of static and rotating gobos.

If other than open hole is selected on the rotating gobo wheel 71 and other than open hole is selected on the fixed wheel 75, then the fixed wheel position is retained 77 and the inquiry repeats at 71.

If other than open hole is selected on the rotating gobo wheel 71 and there is no selection other than open hole on the fixed wheel 75, then the large size aperture on the fixed wheel is automatically selected 76 and the inquiry repeats at 71.

If there is no other than open hole selected on the rotating gobo wheel 71 and other than open hole is selected on the fixed wheel 72, then the fixed wheel position is retained 74 and the inquiry repeats at 71.

If there is no other than open hole selected on the rotating gobo wheel 71 and there is no selection other than open hole on the fixed wheel 72, then the medium size aperture on the fixed wheel is automatically selected 73 and the inquiry repeats at 71.

In a further embodiment of the invention the light control system makes further use of the static gobo wheel 37 to minimize light spill from the luminaire when it is dimmed to blackout. The discharge lamps used in automated luminaires such as lamp 32 shown herein cannot typically be electrically dimmed to a full blackout. Enough current has to be left running to maintain the arc discharge. Thus, to obtain a full blackout of the luminaire, a secondary dimming or shutter system such as 49 must be provided. These systems are typically mechanical utilizing blades, shutters, iris diaphragms or similar devices well known in the art to selectively restrict light from the optical system thus dimming it. At the extreme position of such a mechanical dimmer the shutter or blade may be completely across the light beam. However, with the short arc, short focal length lamps described herein, extreme angle light may still be able to escape through or around the dimmer system resulting in objectionable ghosting of stray light and an incomplete blackout. The light control system described recognizes when the mechanical dimmer is in its minimum, or blackout, position and automatically moves the static gobo wheel 37 to the nearest position intermediate between two patterns or gobos thus providing a secondary block to stray light. For example, as shown in FIG. 6, if the static gobo wheel is in position such that gobo 58 is being used and is across the light beam and the user issues the command to black out the luminaire, then the light control system will automatically move static gobo wheel 37 to position 62 that is intermediate between gobos 58 and 60. This is a position where no light can pass through the wheel so that it provides a secondary block to spill light. Similarly, for any other position on the static gobo wheel 37, on receiving the blackout command the wheel will rotate one half of a step to the closest intermediate position between two gobos. This small rotation may happen very quickly and is not noticeable to the user or the audience. Upon opening the dimmer again and coming out of blackout, the static gobo wheel 37 will return to its original position.

FIG. 9 illustrates an embodiment of a logic flow chart of the control of the light control system during a mechanical blackout. If the mechanical dimmer is in a blackout position 82 and the fixed wheel is in the large aperture position 84, then the fixed wheel is moved 1 and ½ positions 90 so it is between gobo positions and the inquiry repeats.

If the mechanical dimmer is in a blackout position 82 and the fixed wheel is not in the large aperture position 84, then (1) if the fixed wheel is between positions 86 then the inquiry repeats (2) if the fixed wheel is not between positions 86 then the fixed wheel is moved ½ position 88 so it is between gobo positions and the inquiry repeats.

If the mechanical dimmer is NOT in a blackout position 82 and the fixed wheel is NOT between gobo positions 92 the inquiry repeats.

If the mechanical dimmer is NOT in a blackout position 82 and the fixed wheel is between gobo positions 92 then the fixed wheel is returned to the last user or automatically selected hole position 94 and the inquiry repeats.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

We claim:

1. An automated multiparameter luminaire comprising:
a light source generating a light beam with a hotspot;
a gobo wheel with a plurality of selectable gobos and an no-gobo open position;
a control system that automatically selects a medium size aperture when the gobo wheel is in the open position and
automatically selects a large aperture when a gobo is selected.

2. The automated multiparameter luminaire luminaire of claim 1 where first gobo wheel has rotating gobos.

3. The automated multiparameter luminaire of claim 3 where some of the gobos are made of a glass.

4. The automated multiparameter luminaire luminaire of claim 1 where the medium aperture and large aperture are selectable positions on a second gobo wheel and the automatic selection of appertures only occurs if no gobo is selected on the second gobo wheel.

5. The automated luminaire of claim 4 where the second gobo wheel is an etched metal.

6. The automated luminaire of claim 4 which also comprises of an electronic and/or mechanical selectable variable dimmer and where when the dim level selected is zero or near zero the control system automatically shifts the second gobo wheel to a position between gobos positions, whereby the gobo wheel blocks the light beam.

7. The automated luminaire of claim 6 where automatic shift is either ½ or 1½ position(s).

8. The automated luminaire of claim 6 where when the dimmer level is raised from the zero or near zero, the second gobo wheel automatically returns to it last known full position.

9. An automated multiparameter luminaire comprising:
a light source generating a light beam with a hotspot;
a gobo wheel with a plurality of selectable gobos and an no-gobo open position;
an electrical and/or mechanical dimmer; and
when the dim level selected is zero or near zero the control system automatically shifts to a position between gobos positions, whereby the gobo wheel blocks the light beam.

10. The automated luminaire of claim 9 where automatic shift is either ½ or 1½ position(s).

11. The automated luminaire of claim 9 where when the dimmer level is raised from the zero or near zero selection, the second gobo wheel automatically returns to it last known full position.
